(19) United States
(12) Patent Application Publication
(10) Pub. No.: US 2018/0089610 A1
(43) Pub. Date: Mar. 29, 2018

(54) GENERATING AND DISPENSING EVIDENCE OF PAYMENT FOR DELIVERY OF A MAIL PIECE USING A MOBILE DEVICE AND NFC TAG

(71) Applicant: Pitney Bowes Inc., Danbury, CT (US)

(72) Inventors: Jesse G. Greco, Naugatuck, CT (US); Andrea Greggo, Gardiner, NY (US)

(73) Assignee: Pitney Bowes Inc., Danbury, CT (US)

(21) Appl. No.: 15/279,905

(22) Filed: Sep. 29, 2016

(51) Int. Cl. G06Q 10/08; H04B 5/00; G06Q 20/04; G06Q 20/10

(52) U.S. Cl. CPC G06Q 10/083; H04B 5/0031; H04W 4/008; G06Q 20/102; G06Q 20/0453

(57) ABSTRACT

A system and method for dispensing evidence of payment for delivery of a mail piece that does not require the user to have a printer readily available to print a label that includes the evidence of payment for delivery is provided. The mail piece sender utilizes a software application operating on a mobile electronic device to determine the cost for delivery of a mail piece. An indicium that evidences payment for the delivery of the mail piece is generated, and the mobile electronic device is utilized to program a Near Field Communication (NFC) tag that is adhered to the mail piece. When the mail piece is received by a carrier, the carrier can read the information stored in the NFC tag to process and deliver the mail piece. Optionally, the carrier can print a label based on the information obtained from the NFC tag for adhering to the mail piece.

### FIELD OF THE INVENTION

The invention disclosed herein relates generally to systems and methods for dispensing evidence of payment for delivery of a mail piece, and more particularly to online payment dispensing systems in which mobile devices and software applications generate and dispense evidence of payment for delivery of a mail piece that is stored in a near field communication (NFC) tag placed on a mail piece.

### BACKGROUND OF THE INVENTION

Payment metering systems generate encrypted information that is printed on a mail piece as part of an indicium evidencing payment for delivery of the mail piece. A mail piece can include any type of letter, flat, parcel, package or the like. The encrypted information includes a payment value for the mail piece combined with other data that relate to the mail piece and the meter printing the indicium. Since the indicium incorporates the encrypted information relating to the evidencing of payment, altering the printed information in an indicium is detectable by standard verification procedures.

Conventional postage metering systems utilize pre-paid accounts in which funds are stored in a register for use to generate and print postage. Such funds are stored in a secure device, known as a postal security device (PSD), which is a secure processor-based accounting device that dispenses and accounts for postal value stored therein. The PSD generates indicia for printing on mail pieces, utilizing the funds stored therein. More recently, postage metering systems have been developed where the accounting structure described above is no longer resident with the user. Sometimes referred to as a “virtual postage meter,” these types of postage metering systems dispense postage electronically over suitable communication channels (LAN, WAN, telephone lines, Internet, etc.). The user maintains an account with a remotely located data center (typically maintained by an authorized postage meter manufacturer) and receives postage in the form of a postal indicium securely using appropriate electronic data interchange techniques. The user can either prepay or is invoiced for the amount of postage dispensed and any other fees associated with maintaining the account with the data center.

In current payment evidencing systems, including those as described above utilized by the USPS, and other system used by other carriers, e.g., Federal Express, UPS, and the like, the received indicium must be printed either directly on the mail piece itself or a label applied to the mail piece. When a user is using a personal computer to request such evidence of payment for delivery, printing on the mail piece or on a label is typically not an issue, as a suitable printer is typically readily available. However, if the user wishes to use a mobile electronic device, such as a smartphone or personal digital assistant, to request such evidence of payment, printing an indicium may be an issue as an appropriate printer is often times not readily available. Thus, there is a need for a system and method for dispensing evidence of payment for delivery of a mail piece that does not require the user to have a printer readily available to print a label that includes the evidence of payment for delivery.

### SUMMARY OF THE INVENTION

The present invention overcomes the problems associated with current payment evidencing systems by providing a system and method for dispensing evidence of payment for delivery of a mail piece that does not require the user to have a printer readily available to print a label that includes the evidence of payment for delivery. The mail piece sender utilizes a software application operating on a mobile electronic device to determine the cost for delivery of a mail piece. An indicium that evidences payment for the delivery of the mail piece is generated, and the mobile electronic device is utilized to program a Near Field Communication (NFC) tag that is adhered to the mail piece. When the mail piece is received by a carrier, the carrier can read the information stored in the NFC tag and use the read information to process and deliver the mail piece. Optionally, the carrier can print a label based on the information obtained from the NFC tag for adhering to the mail piece. The sender of the mail piece, however, does not need to print a label.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate presently preferred embodiments of the invention, and together with the general description given above and the detailed description given below, by way of example serve to explain the invention in more detail. As shown throughout the drawings, like reference numerals designate like or corresponding parts.

FIG. 1 illustrates in block diagram form a system according to an embodiment of the present invention; and

FIG. 2 illustrates in flow diagram form the operation of the system of FIG. 1 according to an embodiment of the present invention.

### DETAILED DESCRIPTION OF THE PRESENT INVENTION

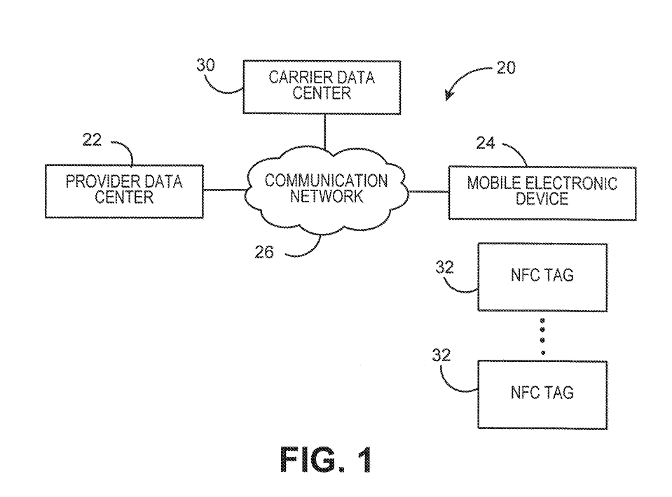

In describing the present invention, reference is made to the drawings, wherein there is seen in FIG. 1 a block diagram of a system 20 for generating and dispensing evidence of payment for delivery of a mail piece according to an embodiment of the present invention. Evidence of payment for delivery of a mail piece may also be referred to as “postage” herein without limiting such term to a postal service. It should be understood, therefore, that any reference to the term postage does not limit the invention to only postal services, and instead can also include any commercial or private carriers in addition to postal services. As described in greater detail below, the dispensing system 10 enables a user to receive and provide evidence of payment for delivery of a mail piece without requiring a printer to print the evidence of payment at time the evidence of payment is dispensed. It should be understood that the system 20 is just one particular embodiment of a postage dispensing system in which the present invention may be implemented, and that the invention as described herein may also be implemented in other configurations and/or embodiments.

The system 20 includes a provider data center 22 that includes a suitable processing system having a computing device such as a server computer and one or more memory components for data storage. Such server computer may be a mainframe or the like that is specially constructed for the required purposes, or it may comprise a general purpose computer selectively activated or reconfigured by a computer program stored therein. Such a computer program may alternatively be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, which are executable by a processing device within the server computer. One of ordinary skill in the art would be familiar with the general components of a server system as utilized herein. The provider data center 22 is maintained and operated by a service provider such as an authorized postage meter manufacturer or some other agency or entity authorized to dispense postage. The provider data center 22 is in electronic communication with one or more suitable wired or wireless communication networks 26, such as a cellular network, the Internet, or the like.

The system 20 also includes a carrier data center 30 that is operated by a carrier for which the provider data center 22 is authorized to dispense evidence of payment for delivery of a mail piece (i.e., postage). The carrier data center 30 includes a suitable processing system having a computing device such as a server computer and one or more memory components for data storage. Such server computer may be a mainframe or the like that is specially constructed for the required purposes, or it may comprise a general purpose computer selectively activated or reconfigured by a computer program stored therein. Such a computer program may alternatively be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, which are executable by a processing device within the server computer. One of ordinary skill in the art would be familiar with the general components of a server system as utilized herein. The carrier data center 30 is operatively coupled to the communication network 26 to enable electronic communication between the provider data center 22 and the carrier data center 30.

As seen in FIG. 1, the system 20 of the preferred embodiment contemplates the use of mobile electronic devices 24 (only one mobile electronic device 24 is shown in FIG. 1 for purposes of clarity of description) in conjunction with Near Field Communication (NFC) tags 32 that are provided to the user of the mobile electronic device 24. Each mobile electronic device 24 may be, for example and without limitation, a smartphone, tablet, a handheld computer, point of sale (PoS) terminal or the like, that has stored thereon a dedicated software application to perform the tasks described below. Each mobile electronic device 24 is also NFC enabled. NFC (near field communication) is a wireless technology that allows for the transfer of data, such as text or numbers, between two NFC enabled devices. NFC tags 32 are preferably in the form of stickers that contain small microchips that include a memory device for storing information and antenna to enable communication with other NFC enabled devices. The information stored in an NFC tag 32 can be provided by a mobile device 24, and can also be read by a mobile device 24 using standard NFC communication protocols

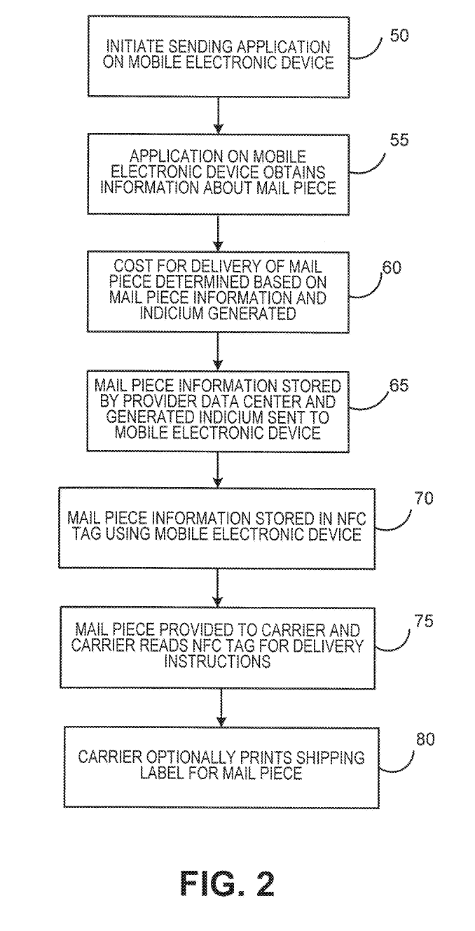

FIG. 2 illustrates in flow diagram form the operation of the system of FIG. 1 according to an embodiment of the present invention. In step 50, a user desiring to send a mail piece initiates a software application, referred to as a “sending app,” stored on their mobile electronic device 24. Upon the first time using the sending app or upon downloading of the sending app, the user is prompted to register the sending app with the provider data center 20 to establish a user account. Such registration can include providing information related to the user, such as a user name, address, contact information, etc., as well a setting up the type of payment account the user wishes to utilize to pay for postage. For example, the user can provide credit card information or information related to other types of payment accounts, e.g., Apple Pay™ or PayPal™ Preferably, the user is required to establish a password or other security feature (e.g., biometrics, voice recognition, etc.) that is required to be entered when starting the sending app to authenticate the user.

Once the sending app has been initiated, then in step 55 the sending app obtains information about the mail piece that is necessary for determining the cost of delivering the mail piece. Such information can include, for example and without limitation, the recipient name and address, physical attributes about the mail piece, including weight and dimensions, a description of the mail piece contents, and the services being requested by the user for delivery (e.g., insurance, priority, overnight, tracking, etc.). Information can be entered manually by the user directly from the mobile electronic device 24. Information can also be obtained in other ways, such as those described in U.S. Pat. No. 8,407,155 B2, issued Mar. 26, 2013, entitled “On-Line Mail Processing System and Mobile Device Application Therefor,” the entire contents of which is hereby incorporated by reference. Briefly as described therein, a digital image of the article for delivery in the mail piece is acquired by an imaging system, e.g., camera, of the mobile electronic device 24, and the article is identified by an image recognition system. Alternatively, a barcode on the article can be scanned to identify the article, or the user can be provided with a list of articles previously sent or perform a search through a catalog. Shipping data about the article is then obtained from a shipping database, e.g., weight, dimensions, description, etc. based on the identified image or barcode.

Information can also be obtained by the sending app directly from the user's mobile electronic device 24. For example, a contact list maintained on the mobile device 24 can be accessed to allow the user to select a recipient of the mail piece, and the contact information imported into the sending app. The user can also select services for the mail piece, including a specific carrier, the type of service (flat rate, priority, overnight, etc.), and any special services (e.g., insurance, signature confirmation, certified mail, etc.).

Once the information about the mail piece is obtained, then in step 60 the information is transmitted to the provider data center 22 to determine the cost for delivery of the mail piece based on the provided information and one or more rate tables stored by the provider data center 22. Optionally, one or more carrier data centers 20 can be queried by the provider data center 22 to determine the costs based on rate tables stored by the carrier data centers 30. If a specific carrier was not selected by the user, the server at the provider data center 22 can include program code to compare rates for a plurality of carriers and provide the lowest cost delivery options. Alternatively, the mail piece information can be provided to a plurality of carrier data centers 30 such that a competitive bid for delivery of the mail piece may be obtained from multiple carriers. It should be understood that the term carrier as used herein is not limited to traditional carriers, e.g., USPS, UPS, Fed Ex, but can also include peer to peer delivery services such as lyft, shipster, UberRUSH and the like. Information can be returned from the provider data center 22 to the mobile electronic device 24 to allow the user to make a selection, if necessary, based on different costs, services and/or carriers that can be used to deliver the mail piece. Once the user has selected the carrier/service, if necessary, then also in step 60, an indicium that evidences payment for delivery of the mail piece is generated by the provider data center 22. The indicium can include any information required by the carrier selected to deliver the mail piece that the carrier can utilize to confirm payment has been made for delivery of the mail piece, along with any additional information desired. Thus, for example and without limitation, an indicium can include information such as the postage amount, type of service to be used for delivering the mail piece, special services to be applied to the mail piece (e.g., tracking, insurance, etc.), sender identification, recipient identification, weight and dimensions of the mail piece, a description of the contents of the mail piece, information related to customs or restrictions on delivery, and so forth. In step 65, the mail piece information, and optionally the generated indicium are stored by the provider data center 22, and the generated indicium is sent to the mobile electronic device 24.

In step 70, the generated indicium is stored in an NFC tag 32 using the mobile electronic device 24. Such programming is generally well known and need not be discussed in full detail for a complete understanding of the present invention. The NFC tag 32 may be applied to the mail piece either before or after the NFC tag 32 has been programmed with the information received from the provider data center 22. The sending app on the mobile electronic device 24 allows for easy programming of the NFC tag 32 with the information received from the provider data center 22. Briefly, upon receipt of the indicium information from the provider data center 22, the sending app asks the user if they want to program an NFC tag 32 or instead print a label to be applied to the mail piece. Upon selecting the option to program an NFC tag 32, the user is instructed to place the mobile electronic device 24 near the NFC tag 32 such that the communication protocol between the two can commence. When the information has been transmitted from the mobile electronic device 24 to the NFC tag 32 and stored therein, the sending app notifies the user of successful programming. The mail piece, with the programmed NFC tag 32 applied thereto, is now ready to be delivered/picked up by the carrier for delivery.

In step 75, the mail piece is either provided to the carrier, such as for example, by dropping the mail piece off at a carrier induction location or placing the mail piece in a receptacle for later retrieval by the carrier, or the carrier can pick up the mail piece. The carrier scans the NFC tag 32 applied to the mail piece to read the delivery instructions for the mail piece stored therein using any suitable handheld device that is NFC enabled. Such reading of an NFC tag is generally well known and need not be discussed in full detail for a complete understanding of the present invention. Depending on the carrier selected for delivery of the mail piece and the delivery infrastructure supported by that carrier, the carrier may still require a printed label adhered to the mail piece for delivery of the mail piece. This may be necessary as the carrier may not have the capability to read the NFC tag 32 at all required points along the delivery system, but instead utilizes either barcode readers or human readable text to properly deliver the mail piece. In such situations, in step 80, the carrier can optionally print a shipping label for the mail piece based on the information stored in the NFC tag 32 and apply the printed label to the mail piece. The printed label can include one or more barcodes and/or human readable information as required by the particular carrier for delivery of the mail piece.

Optionally, the information stored in the NFC tag 32 can be encrypted to prevent the unauthorized reading of such information. Encrypting the information can be performed by the provider data center 22 using any suitable encryption program before the information is sent to the mobile electronic device 24, or can be performed by the mobile electronic device 24 before the NFC tag 32 is programmed. A corresponding decryption program is provided to each carrier such that upon reading of the NFC tag 32, the information can be sent to the carrier data center 30 for decryption.

While preferred embodiments of the invention have been described and illustrated above, it should be understood that they are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method for a carrier to process a mail piece for delivery, the method comprising:
receiving the mail piece, the mail piece including a near field communication (NFC) tag adhered thereto, the NFC tag including a memory having information related to the mail piece stored therein;
reading, by the carrier using an electronic device, the information related to the mail piece stored in the memory of the NFC tag; and
printing, by the carrier using a printing device, a label for the mail piece that includes the information related to the mail piece.

2. The method of claim 1, wherein the information related to the mail piece includes evidence of payment for delivery of the mail piece.

3. The method of claim 1, wherein the information related to the mail piece includes at least one of a postage amount, a type of service to be used for delivering the mail piece, special services to be applied to the mail piece, an identification of a sender of the mail piece, an identification of a recipient of the mail piece, a weight of the mail piece, dimensions of the mail piece, and a description of the mail piece.

4. The method of claim 1, wherein the information stored in the memory is encrypted, the method further comprising:
decrypting the information related to the mail piece that is read from the NFC tag.

5. A method for a sender to prepare a mail piece for delivery by a carrier to a recipient, the method comprising:
using a software application running on a mobile electronic device to determine information related to delivery of the mail piece by the carrier to the recipient; and
programming a near field communication (NFC) tag, using the mobile electronic device, to store the information related to delivery of the mail piece, the information related to delivery of the mail piece sufficient to allow the carrier to deliver the mail piece to the recipient,
wherein the sender does not have to print a label for the mail piece.

6. The method of claim 5, wherein the information related to delivery of the mail piece includes evidence of payment for delivery of the mail piece.

7. The method of claim 5, wherein the information related to delivery of the mail piece includes at least one of a postage amount, a type of service to be used for delivering the mail piece, special services to be applied to the mail piece, an identification of a sender of the mail piece, an identification of a recipient of the mail piece, a weight of the mail piece, dimensions of the mail piece, and a description of the mail piece.

8. The method of claim 5, wherein the information related to delivery of the mail piece is encrypted before being stored in the NFC tag.
